(19) United States
(12) Patent Application Publication
(10) Pub. No.: US 2012/0301128 A1
(43) Pub. Date: Nov. 29, 2012

(54) Viewfinder

(76) Inventors: Richard E. Feinbloom, New York, NY (US); David B. Soll, Ambler, PA (US)

(21) Appl. No.: 13/524,022

(22) Filed: Jun. 15, 2012

Related U.S. Application Data
(63) Continuation-in-part of application No. 12/927,895, filed on Nov. 29, 2010, now Pat. No. 8,213,788.
Application No. 12/927,895 is a continuation-in-part of application No. 12/358,456, filed on Jan. 23, 2009, now abandoned.

(51) Int. Cl. G03B 13/02

(52) U.S. Cl. 396/373

(57) ABSTRACT

According to an aspect of the invention, a case or slide-on unit suitable for containing an electronic device is disclosed. The case or slide-on unit incorporates a viewfinder housing assembly that allows a user to view an image when taking a picture with the electronic device. The housing assembly includes a sighting grid that allows a user to orient an image within a field of view in order to properly capture the image

### CLAIM OF PRIORITY

This application claims, pursuant to 35 USC §120, as a Continuation-in-Part, priority to and the benefit of the earlier filing date of, that patent application entitled Viewfinder, filed in the US Patent Office on Nov. 10, 2010 and afforded Ser. No. 12/927,895, the contents of which is incorporated by reference, herein.

This application further claims, pursuant to 35 USC §120, as a Continuation-in-Part, priority to and the benefit of the earlier filing date of, that patent application entitled Viewfinder, filed in the US Patent Office on Jan. 25, 2012 and afforded Ser. No. 12/358,456, which is a continuation-in-part of that patent application entitled Viewfinder, filed in the US Patent Office on Nov. 10, 2010 and afforded Ser. No. 12/927,895, the contents of which are incorporated by reference, herein.

### FIELD OF THE INVENTION

The invention relates generally to viewfinders, and more particularly, to viewfinders for electronic devices suited for taking digital photographs.

### BACKGROUND OF THE INVENTION

Digital photography is popular worldwide, yet many digital compact cameras and presently cell phones do not have viewfinders. Viewfinders are used to compose and frame a scene. When present, the viewfinder on a digital camera may be either an optical viewfinder that works through the lens, or an electronic viewfinder, which is a small LCD, both of which are formed as an integral part of the camera. Optical viewfinders have disadvantages, however, since the viewfinder shows only about 70-75% of what the camera lens actually “sees”. The electronic viewfinder also has disadvantages, as it may not be as clear as an optical viewfinder, but it does show the entire area to be photographed. In view of the problems associated with viewfinders, it is becoming increasingly difficult to find a commercially-available digital camera with a viewfinder; there are no available viewfinders for cell phones.

When no viewfinder is present on a camera, many use the LCD screen to frame a shot for a photograph. Cellular telephones also have an LCD screen which may be used to frame a scene. Digital cameras or cellular telephones that have only an LCD screen and no viewfinder may cause the photographer using the device to hold it approximately 18 inches or at arm's length from the eyes so the image is visible on the LCD screen, but the photographer can only estimate the focus and composition of the image at this distance. Viewing the LCD screen can be difficult also in brightly-lighted and sunlit areas, as there can be significant glare on the viewing screen, leaving the photographer with the need to use a hand or other device to shade the LCD screen.

Thus, there remains a need for viewfinders for electronic devices suited for taking digital photographs.

### BRIEF DESCRIPTION OF THE DRAWINGS

It is to be understood that the accompanying drawings are solely for the purposed of illustrating the concepts of the invention and are not drawn to scale. The embodiments shown in the accompanying drawings, and described in the accompanying detailed description, are to be used as illustrative embodiments and should not be construed as the only manner of practicing the invention. Also, the same reference numerals, possibly supplemented with reference characters, where appropriate, have been used to identify similar elements.

FIG. 1 is an elevational view of the device according to an aspect of the invention;

FIG. 2 is a side view of the device according to an aspect of the invention;

FIG. 3 is a side view of the device disposed on an electronic device; and

FIG. 4 is a back view of the device disposed on an electronic device.

FIG. 5 is a prospective front view of a viewfinder assembly on an electronic device in accordance with an aspect of the invention

FIG. 6 is a prospective back view of the viewfinder assembly shown in FIG. 5.

FIGS. 7A and 7B illustrate prospective front and back views of a viewfinder assembly in accordance with another aspect of the invention.

FIGS. 8A and 8B illustrate prospective front and back views of a viewfinder assembly in accordance with another aspect of the invention.

FIGS. 9A and 9B illustrate prospective front and back views of a viewfinder assembly in accordance with an aspect of the invention.

FIG. 10 illustrates a close-up view of an exemplary attachment means for a viewfinder assembly in accordance with an aspect of the invention.

FIG. 11 illustrates a close-up view of an exemplary attachment of a viewfinder assembly in accordance with the principles of the invention.

FIG. 12 illustrates a close-up view of an attached viewfinder assembly in accordance with the principles of the invention.

FIGS. 13A and 13B illustrate another exemplary embodiment of a viewfinder assembly in accordance with the principles of the invention.

### SUMMARY OF THE INVENTION

According to an aspect of the invention, a case, or device, suitable for containing an electronic device is disclosed which incorporates a viewfinder housing assembly, that allows a user to view an image when taking a picture with the electronic device. The housing assembly includes a sighting grid that allows a user to orient an image within a field of view in order to properly capture the image. The viewfinder can be attached so the image is horizontal or vertical.

According to another aspect of the invention, a viewfinder housing is removably attached to a case for containing an electronic device. The viewfinder housing allows a user to view an image when taking a picture with the electronic device. The viewfinder housing includes a grid that allows a user to orient an image within a field of view in order to properly capture the image.

According to another aspect of the invention, a case suitable for containing an electronic device which includes means for engaging a viewfinder housing when the electronic device is in either a horizontal or a vertical orientation is disclosed. The viewfinder housing can be removed from the case so that the viewfinder housing may be positioned so that images may be viewed when the electronic device is in a vertical or a horizontal position.

### DETAILED DESCRIPTION OF THE INVENTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In all instances, the terms “about” may include numbers that are rounded to the nearest significant figure.

It is understood that the figures and descriptions of the present invention have been simplified to illustrate elements that are relevant for a clear understanding of the present invention while eliminating, for the purpose of clarity many other elements known in the art. Those of ordinary skill in the art would recognize that other elements and/or steps are desirable and/or required in implementing the present invention. However because such elements and steps are well known in the art and because they would not facilitate a better understanding of the present invention a discussion of such elements and steps are not provided herein.

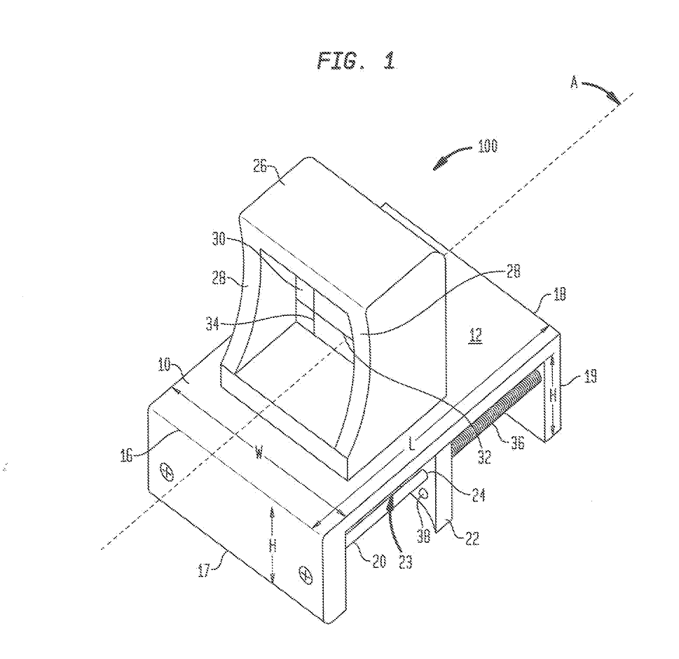

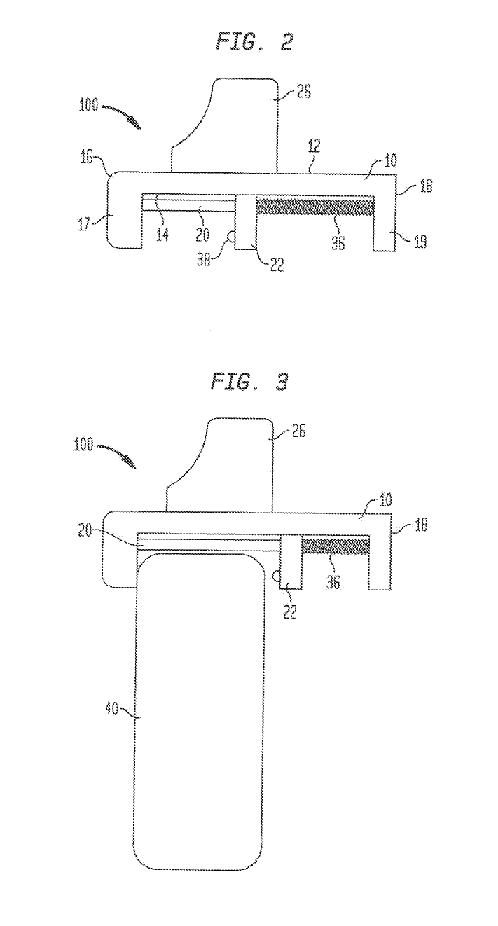

Referring to FIG. 1, according to an aspect of the invention, a viewfinder 100 including a base member 10 for removably mounting on an electronic device is illustrated. The base member 10 includes a top surface 12 and a bottom surface 14 (FIG. 2), both of which may be substantially planar. Base member 10 also includes a first end 16 and a second end 18. The first end 16 and second end 18 each include rod support members 17 and 19, respectively. Rod support members 17 and 19 extend downwardly from the first end 16 and second end 18, respectively. According to an aspect of the invention, the second rod support member 19 may be shorter in height than the first rod support member 17.

One or more rods 20 are coupled to the base member 10 by a suitable attachment device, depicted in FIG. 1 as screws. Other alternative and conventional means for attachment of the rods 20 may also be used. The rods 20 may be formed of a suitable material, for example, metal or rigid plastic. As illustrated in FIG. 2, the rods 20 are disposed adjacent the bottom surface 14 of the viewfinder 100.

Referring to FIG. 1, a spring-like wire 36 is disposed about each of the one or more rods 20. The spring-like wire 36 is disposed along a length of a rod between the second rod support member 19 and the sliding member 22.

Referring to FIG. 1, coupled to the base member 10 is a sliding member 22. The sliding member 22 includes one or more apertures 24 extending from one side of the member 22 to the opposite side, for receiving one or more rods 20. The rods 20 also provide for the slidable coupling of the sliding member 22 to the base member 10. The sliding member 22 as illustrated in FIG. 1 is disposed on the viewfinder 100 between the rod support members 17 and 19. A first rod 20 is illustrated as extending through a corresponding aperture 24 in the sliding member 22. A second rod 20 in parallel with the first rod 20 is also present on the viewfinder 100, although one centrally-located rod 20 may be suitable for use according to an aspect of the invention.

The sliding member 22 may further include one or more stops 38. Stops 38 may be substantially hemi-spherical in shape, although other configurations are envisioned. For example, the stops may be square rubber pads, or formed of other suitable material, including rigid or semi-rigid foam. As illustrated, the stops 38 are disposed adjacent the bottom of the sliding member 22 on the side facing the first end 16 and rod support member 17.

Sliding member 22 also may include a cutaway portion 23 to provide ease in grasping and moving the sliding member 22. It should be understood that although the cutaway portion 23 as illustrated is arc-shaped, any suitable geometric shape may be used.

Referring still to FIG. 1, disposed on the top surface 12 of the base member is a housing 26. The housing 26 is open at both ends, and is substantially rectangular. At one open end of the housing 26 there are slightly curved portions 28, and at the opposite, open end of the housing 26 a sighting grid 30 is disposed.

The sighting grid 30 may include one or more horizontal lines 32 intersecting with one or more vertical lines 34. The sighting grid 30 may be used to center a subject or to use as a guide in preventing parallax error, as herein described. Although the sighting grid 30 is described as including one or more horizontal lines intersecting with one or more vertical lines, it should be understood that different orientations for the sighting grid 30 are possible. For example, the lines may intersect to form triangles, parallelograms, and other geometrical shapes.

The base member 10 and the housing 26 may be formed of a rigid plastic material, to provide sufficient rigidity to the viewfinder 100 and to maintain the integrity of the viewfinder 100 on an electronic device. The rigid plastic may be molded. Suitable materials include, but are not limited to: polyethylene, polypropylene, and silicon. Although a rigid plastic is described, other suitable, lightweight materials may also be employed.

Suitable dimensions for base member 10 of the viewfinder include, but are not limited to: from about 1¾ to about 2 inches in length, and about 1½ to about 1¾ inches in width. The dimensions of the housing 26 are from about ¾ inch at the interface of the housing 26 with the top surface 12 of the base member 10, and about ½ inch at the opposite end thereof. The height of the housing is about ¾ inch to about 1 inch. It should be understood that the dimensions of the device are not critical, and may be modified to accommodate the different widths and shapes of electronic devices.

Referring to FIGS. 2 and 3, the movement of the sliding member 22 and mounting of the viewfinder 100 on an electronic device 40 is illustrated. In FIG. 2, a side view of the sliding member 22 is illustrated. To mount the viewfinder 100 on an electronic device 40, the sliding member 22 is pushed or pulled along the one or more rods 20 toward the second end 18 of the base member 10, which compresses the spring-like wire 36. When the sliding member 22 is moved a sufficient distance to receive an electronic device 40, the sliding member 22 is released, and the spring-like wire 36 helps maintain the viewfinder 100 in place. When present, the stops 38 also help maintain the viewfinder 100 on the device 40. The viewfinder 100 is easily removed by moving the sliding member 22 toward the second end 18 of the base member 10, and removing the viewfinder 100 from the device 40.

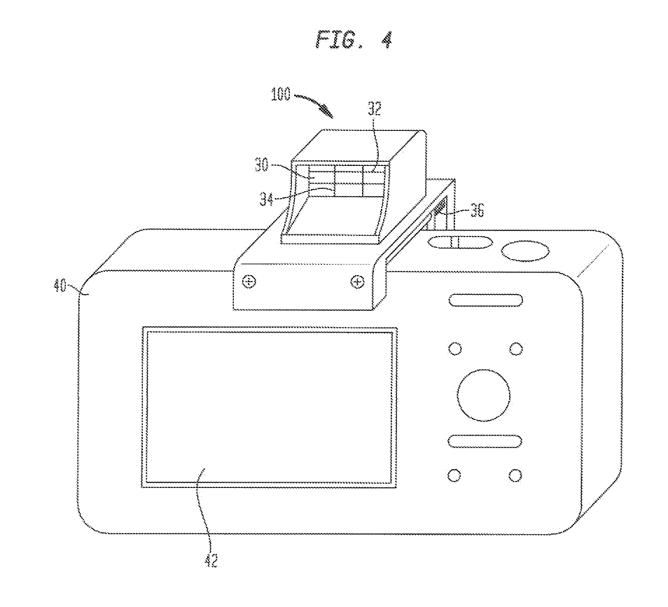

As illustrated in FIG. 4, a viewfinder 100 is illustrated, in context, on a digital camera. The viewfinder 100 may be used on an electronic device suitable for taking digital photographs 40, including digital cameras and cellular telephones. As described herein, the viewfinder 100 may also be used on a suitable cellular telephone that includes a similar viewing screen 42. As illustrated, the viewfinder 100 is mounted perpendicular to the body of the camera, and is not disposed at an angle, i.e., the central axis A (FIG. 1) of the viewfinder 100 is parallel with the central axis of the camera lens.

During photography, there may be slight difference between the frame which is shot by the camera or cell phone, and the frame seen through the viewfinder. The difference is referred to as parallax error. Parallax is an apparent difference or displacement in the position of an object when viewed along two different lines of sight. The difference or displacement is measured in terms of the angle of inclination between the different lines of sight. Since the viewfinder will likely be located about one inch above or to the side of the lens, one using the viewfinder will see the subject from a slightly different angle than the lens. In order to correct the error, it should be understood that one taking the photographs may need to take several photographs to identify the amount of difference, particularly when taking macro photographs. In doing so, the lines of the sighting grid may be suitably used to assist the user to correct the apparent difference. The problem does not tend to occur when taking long-range photographs, as the difference is almost unnoticeable at long distances.

Advantageously, the removably mountable viewfinder 100 according to the invention is easy to place on a camera or cell phone, is easy to carry as it takes up minimal space, is inexpensive and easy to manufacture, and helps one in taking digital photographs, particularly in brightly-lit areas. For example, a user may direct a viewfinder disposed on a suitable electronic device toward an image, including a person, a landscape, or an object. Using the lines of the grid as a guide, one may take a photograph without having to look at the LCD or other type of viewing screen. As a further advantage, by using the viewfinder, one can steady the camera or cellular phone by bracing it against or close to the face, making the camera or phone less prone to shake.

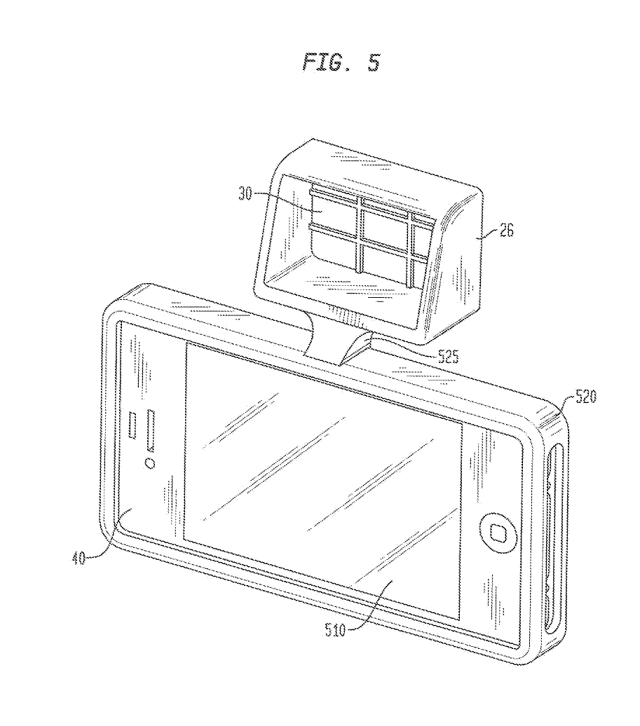

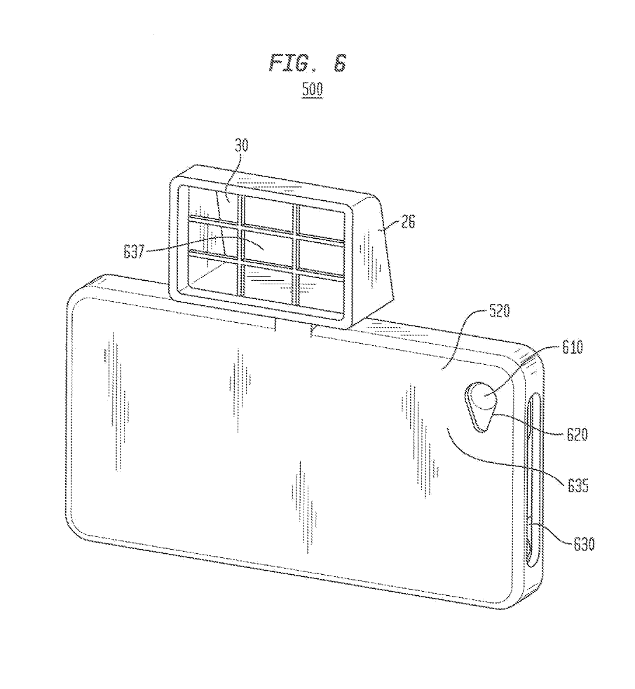

FIGS. 5 and 6 illustrates prospective front and back views, respectively, of a viewfinder assembly in accordance with another embodiment of the invention. In this embodiment of the invention, the viewfinder assembly comprises a case 520 that contains electronic device 40. In this case, the case 520 has an open front surface through which a display screen 510 of the electronic device 40 may be viewed. In this case, the electronic device 40 may represent a cellular telephone, often referred to as a smart-phone, which provides services, such as a camera and video function, in addition to a typical voice and data communications. In addition, the electronic device 40 may represent tablet PC type devices that operate similar to cellular telephones. For example, the electronic device 40 may represent an IPAD tablet PC manufactured by Apple Company. IPAD and APPLE are registered trademarks of the Apple Company, Cupertino, Calif.

Extending from case 520 is a stem or extension 525 on to which a viewfinder housing 26 is attached. The stem or extension 525 offsets the viewfinder housing 26 from the back-surface of the electronic device 40. The viewfinder housing 26 includes a viewfinder element comprising a plurality of horizontal and vertical elements, as previously described. As housing 26 is similar to that described with regard to FIG. 1, a description of housing 26 is not repeated with regard to the following figures.

In a preferred embodiment of the invention, stem or extension 525 offsets the viewfinder housing 26 with regard to a plane parallel to the direction of the display screen 510. In addition, stem or extension 525 positions the housing an angle that is depressed from an optical axis of the electronic device 40. Preferably, the housing is depressed between an angle of zero to three degrees to account for any parallax effect between the lens of the electronic device 40 and the viewfinder grid 30.

FIG. 6 illustrates a prospective view of a back view of the viewfinder assembly 500 in accordance with the principles of the invention. In this prospective view, the case 520 completely covers the electronic device 40. In addition, the case 520 includes opening 620 through which lens 610 of electronic device 40 is visible. As shown is an exemplary slot 630 through which access to a power connection and/or an audio connection may be made.

FIG. 6 also illustrates the orientation of housing 26 having an optical axis 637 that is oriented at an angle at is different than the optical axis 635 of lens 610. The different angle orientation (in the order of zero to three degrees) provides for correction of any parallax caused by the different positions of the viewfinder grid 30 and the lens 610.

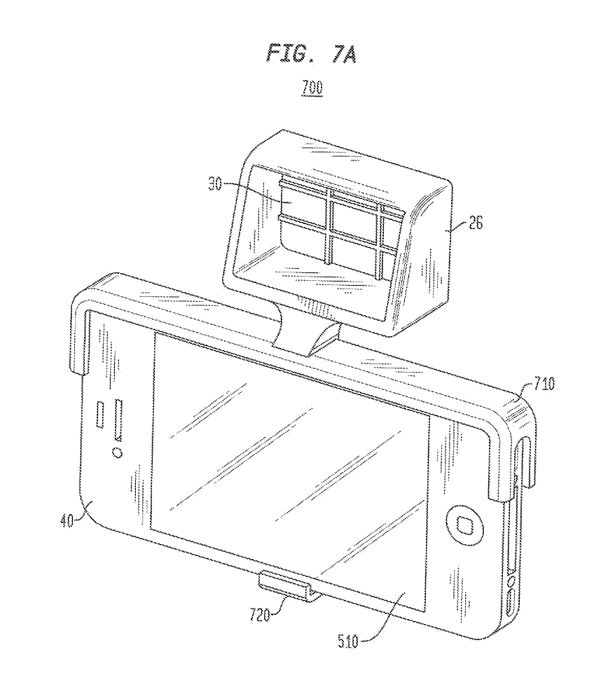

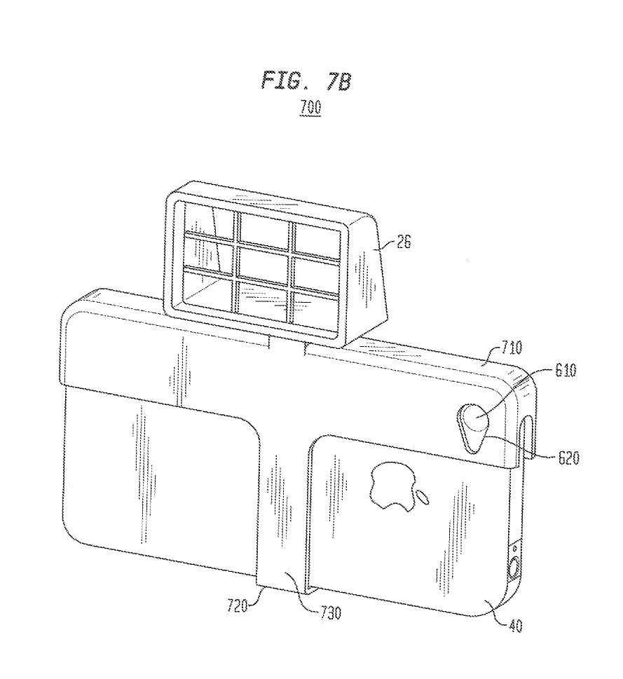

FIGS. 7A and 7B illustrate front and back prospective views of an exemplary viewfinder assembly 700, in accordance with another embodiment of the invention. FIG. 7A illustrates case 710 partially covering electronic device 40, wherein the viewfinder housing 26 is attached to case 710 as previously described with regard to FIG. 5. In addition, case 710 includes a tab 720, which engages a lower surface of electronic device 40 to retain case 710 in place on electronic device 40.

FIG. 7B illustrates a back prospective view of viewfinder assembly 700 shown in FIG. 7A. In this exemplary case, case 710 includes opening 620 through which lens 610 may be viewed. Also shown is extension bar 730 that extends from an upper portion of case 710 to tab 720 to retain case 710 onto electronic device 40.

Viewfinder housing 26 is attached to case 710 in a manner similar to that described with regard to FIGS. 5 and 6 and, hence, a description of viewfinder housing 26 is not repeated with regard to the embodiment shown in FIGS. 7A and 7B.

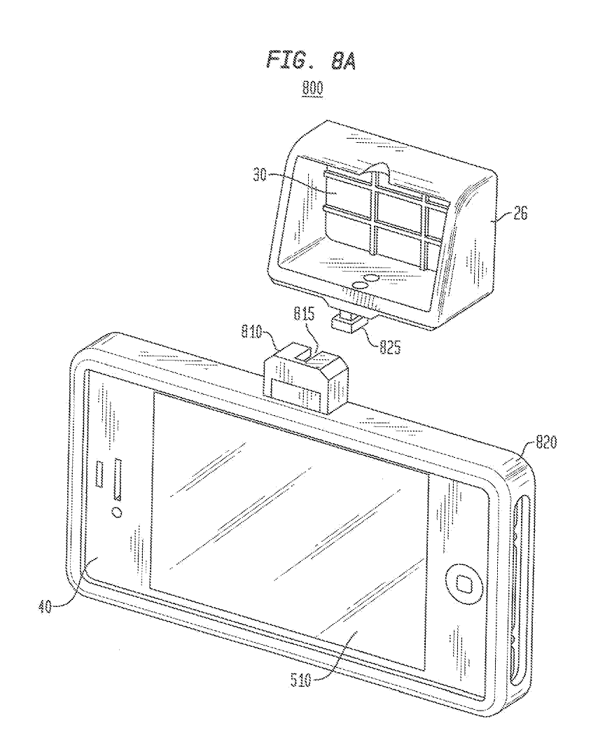

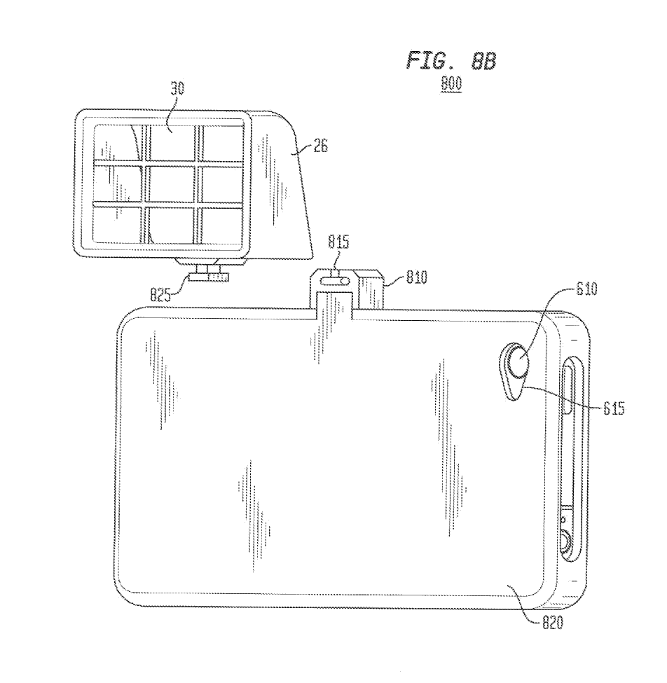

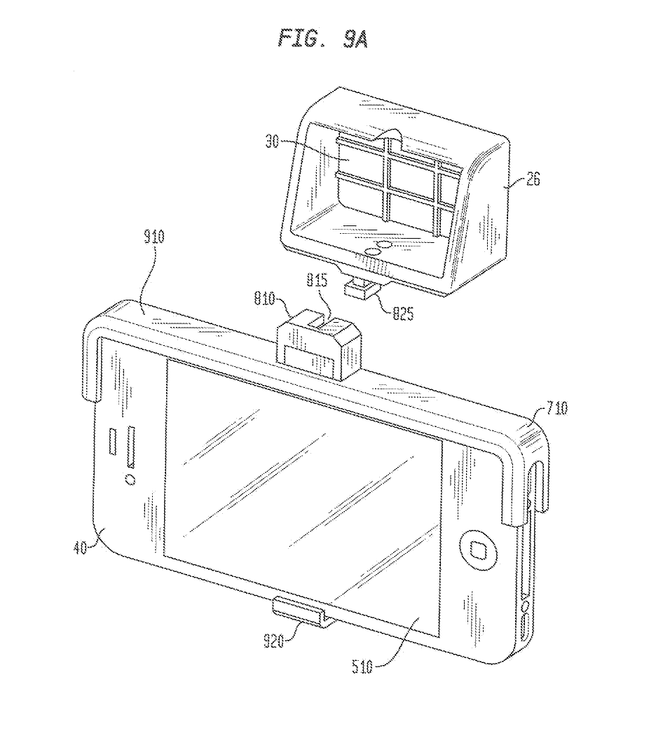

FIGS. 8A and 8B illustrate front and back prospective views of a viewfinder assembly 800 in accordance with another embodiment of the invention. FIG. 8A illustrates a case 820 that is similar to case 520 shown in FIG. 5. In that the case fully covers a back surface of electronic device 40 (see FIG. 8B). Also shown, is an assembly 810, in place of stem 526, that includes an engagement means 815 that is substantially perpendicular to case 820. The viewfinder housing 26 is detached from case 820 and includes a means 825 for attaching housing 26 to case 820 through assembly 810. In one aspect of the invention, the term “substantially perpendicular” in addition to representing the conditions of manufacturing tolerance values with regard to the orientation of the assembly 810 with regard to the electronic device 40 also refers to the positioning and/or orientation of the assembly 810 such that the assembly 810 may orient the viewfinder housing 26 at an angle between zero (0) degrees and three (3) degrees with respect to the optical axis of the lens of the electronic device 40. In this case, an orientation of the viewfinder 26 at zero (0) degrees with respect to the optical axis of the lens of the electronic device 40 represents the viewfinder housing 26 being substantially in parallel to the optical axis (i.e., assembly 810 is oriented substantially perpendicular to the optical axis of the lens of electronic device 40. Alternatively, an angle of three (3) degrees, for example, represents an orientation of the viewfinder housing 26 such that the optical axis of the viewfinder housing 26 intersects the optical axis of the lens of the electronic device 40 at an angle of three degrees. In this case, the assembly 810 may be orientated at an angle of substantially 87 degrees with respect to the electronic device 40.

FIG. 8B illustrates a prospective view of a back of case 820 shown in FIG. 8A. Case 820, similar to case 520 includes opening 615, through which lens 610 of electronic device 40 may be viewed. Also shown is assembly 810 that includes engagement means 815 that extends substantially perpendicular to case 820. In addition, the engagement means 815 includes a horizontal slot that intersects a substantially perpendicular element of engagement means 815. The engagement means 815 is referred, herein, as a “T-slot-female.” Although engagement means 815 is referred to as being substantially perpendicular to case 820, it would be recognized that the engagement means 815 is positioned on case 820 to orient the housing 26 at a desired depression angle, as previously discussed. Although the present invention is described with regard to a “T-slot” engagement means, as shown, it would be recognized by those skilled in the art that the engagement means may be altered without changing the principles or the scope of the invention claimed. For example, the engagement means may also be one of a keyway slot, a tapered slot, a snap fit, a magnetic coupling and a screw attachment. Other engagement means have also been considered and considered to be within the scope of the invention.

Housing 26 includes a similar “T” configuration 825 that includes a substantially perpendicular member that intersects a substantially horizontal member. The “T-slot” 825, referred to a “T-slot-male” engages “T-slot-female” 815 in order to attach or retain housing 26 onto assembly 810. While assembly 810 is shown to include “T-slot-female” 815 and housing 26 including “T-slot-male” 825, it would be recognized that assembly 810 may include a male “T” and housing 26 may include a female T without altering the scope of the invention.

In addition, in the illustrated embodiment, housing 26, when engaged with case 820, is oriented at an angle as previously described with regard to FIG. 5, for example.

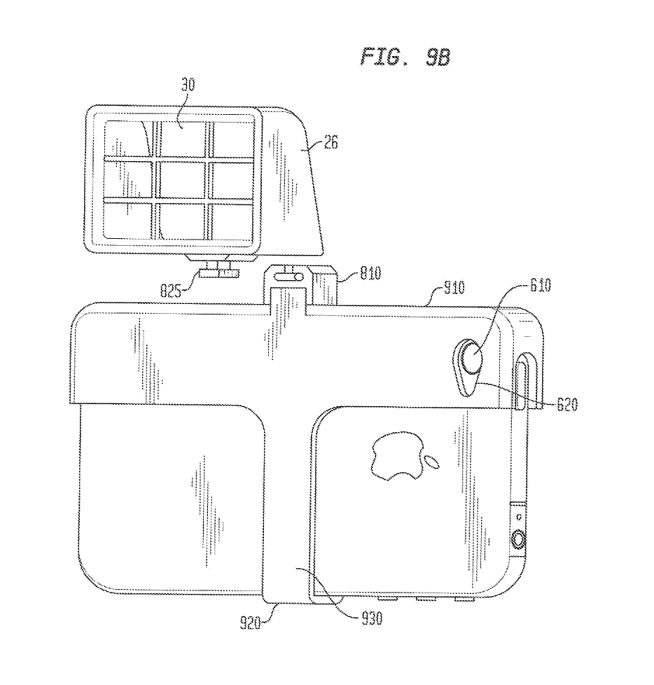

FIGS. 9A and 9B illustrate another embodiment of the invention, similar to that shown in FIGS. 7A and 7B, wherein a case 910 partially covers electronic device 40 along a top edge and is retained by tab 920 attached to a bottom edge of electronic device 40. Case 910 includes an assembly 810, similar to that described with regard to FIGS. 8A and 8B, and allows housing 26 to be attached and removed from case 910, as has been described previously. A description of the means for attaching housing 26 to assembly 810 need not be repeated again.

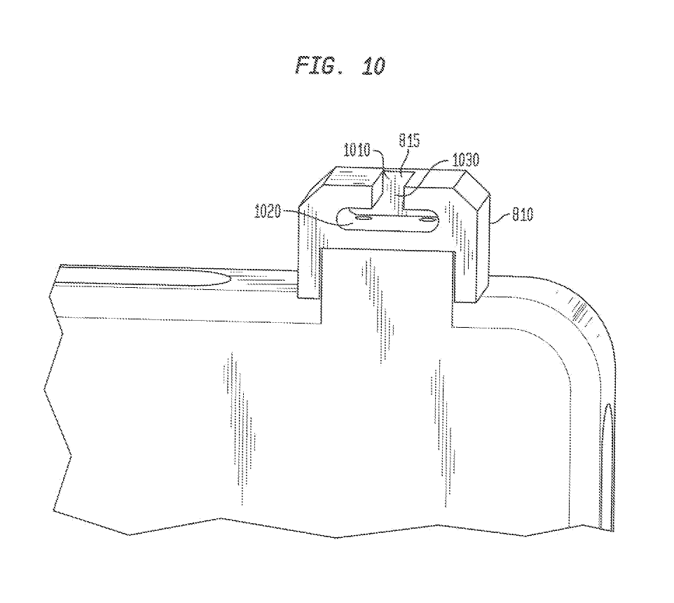

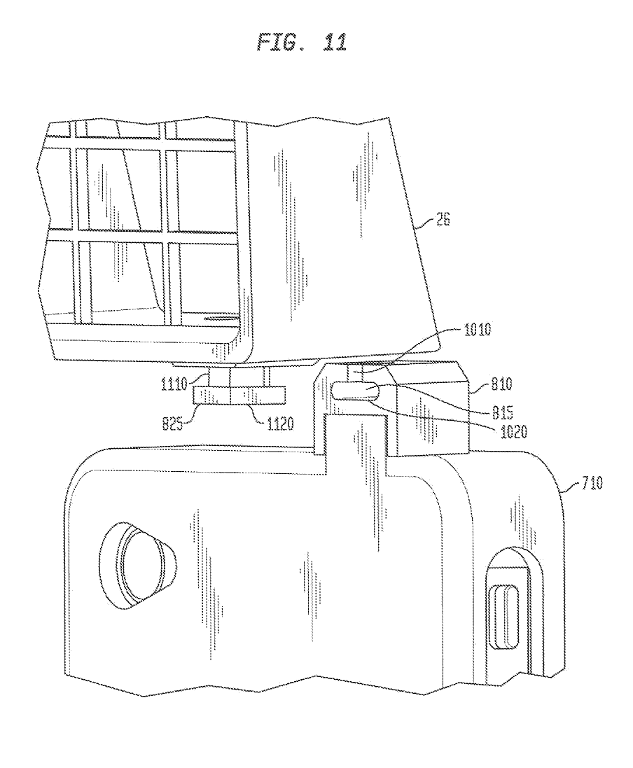

FIG. 10 illustrates detailed view of assembly 810 that provides a means for attaching and removing housing 26 (not shown) to a corresponding case. In this illustrated embodiment, the T-slot-female engagement means 815 includes a substantially vertical slot 1010 that extends from an upper surface of assembly 810 to a substantially horizontal slot 1020. Engagement means 815 includes a back wall 1030 that provides a stop mechanism that prevents means 815 from being a pass-through.

FIG. 11 includes detailed view of housing 26 engaging casing 710. In this illustrated case, housing 26 includes male T-assembly 825 that includes a substantially perpendicular member 1110 extending from a bottom surface of housing 26 and a member 1120 substantially perpendicular to member 1110. Members 1110 and 1120 engage slots 1010 and 1020, respectively, assembly 810.

In one aspect of the invention, housing 26 and member 1110 may be offset from a perpendicular relationship in order to orient housing (or grid) at a slight depression angle, when housing 26 is engaged with case 710. In another aspect of the invention, housing 26 and member 1110 may be substantially perpendicular and T-slot 815 may be oriented at an angle with respect to assembly 810 to orient housing 26 at a desired depression angle, when housing 26 is engaged with case 710. In still another aspect of the invention, assembly 810 may be oriented at a slight angle with respect to the case 710 to provide a desired depression angle to housing 26 when housing 26 is engaged with assembly 810.

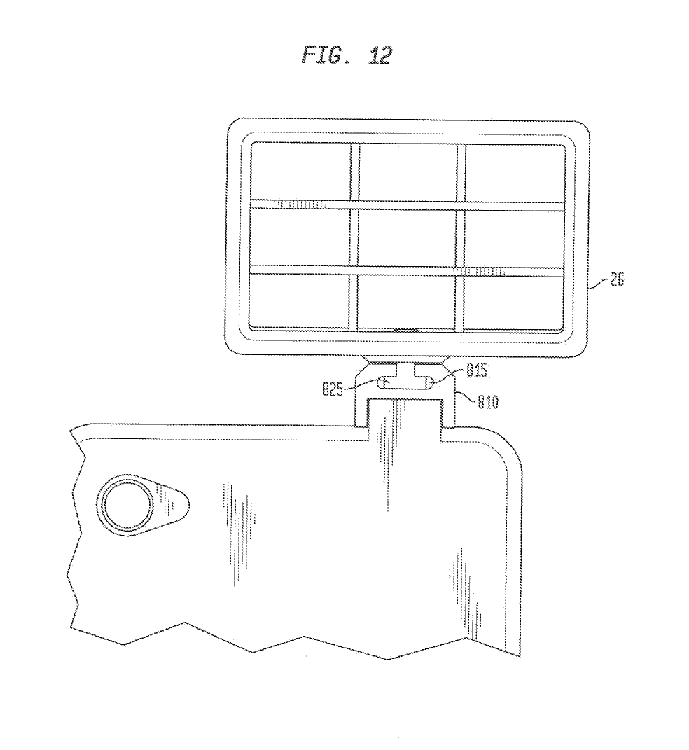

FIG. 12 illustrates a detailed view of housing 26 engaged with assembly 810 by sliding engagement means 825 into engagement means 815 within assembly 810. As previously discussed, when housing 26 is engaged with assembly 810, housing 26 is oriented at a slight depression angle with respect to an optical axis of the electronic device 40 to account for any parallax effect created by the different locations of the viewfinder sighting grid 30 and the lens 610.

Although the invention has been described with regard to a horizontal orientation of the electronic device 40, it would be appreciated that it would be within the knowledge of those skilled in the art to provide an assembly 810 such that the electronic device in a vertical orientation. Hence, such a modification of the invention claimed to develop a case that allows for attachment of housing 26 when the electronic device is in a vertical orientation has been contemplated and considered to be within the scope of the invention claimed.

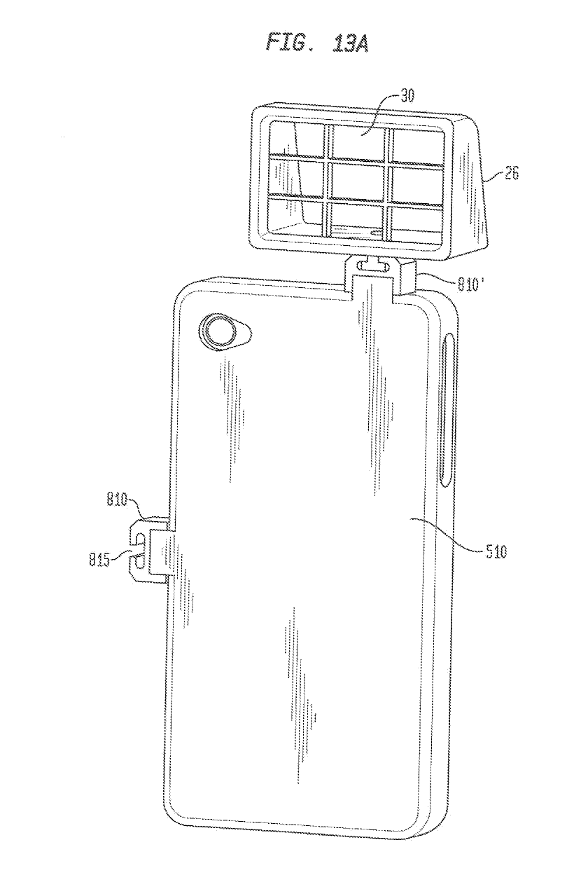

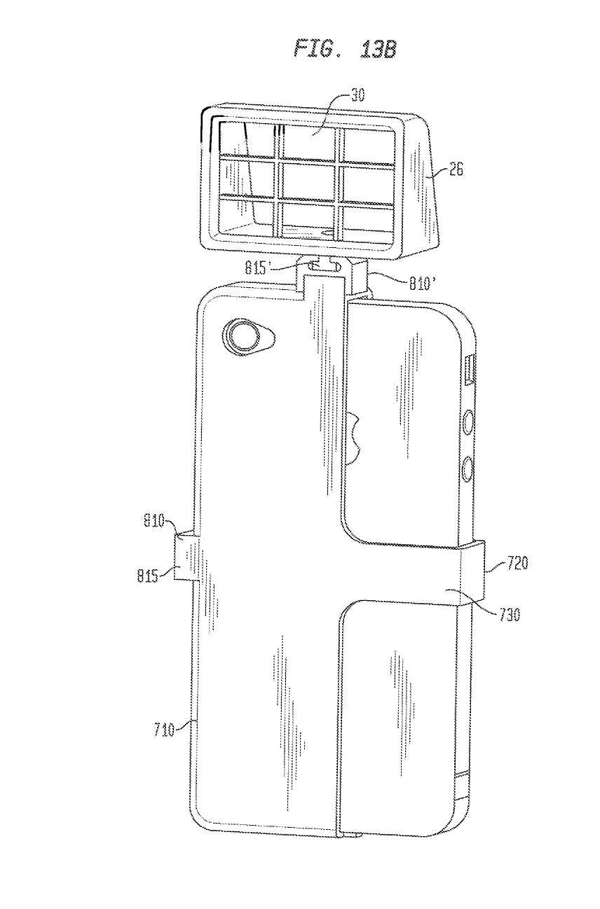

FIGS. 13A and 13B illustrate still additional embodiments of the invention. FIG. 13A illustrates a case 510, shown in FIG. 5, wherein two engagement means (assemblies 810 and 810′) are incorporated into the case 510. In this manner, housing 26 may engage the assembly 810 when the electronic device 40 is oriented in a horizontal direction and may engage the assembly 810′ when the electronic device 40 is oriented in a vertical direction.

FIG. 13B illustrates a case 710, shown in FIG. 7, wherein two engagement means (assemblies 810 and 810′) are incorporated into the case 510. In this manner, housing 26 may engage the assembly 810 when the electronic device 40 is oriented in a horizontal direction and may engage the assembly 810′ when the electronic device 40 is oriented in a vertical direction.

The invention has been described with reference to specific embodiments. One of ordinary skill in the art, however, appreciates that various modifications and changes can be made without departing from the scope of the invention as set forth in the claims. For example, the sighting grid is described without a lens, although a suitable lens may also be disposed in the housing of the viewfinder according to an aspect of the invention. In addition, other means of attachment, whether permanent or by other conventional removable mechanisms may also be used. Accordingly, the specification is to be regarded in an illustrative manner, rather than with a restrictive view, and all such modifications are intended to be included within the scope of the invention.

Although the invention has been described with regard to orienting the housing 26 with regard to the optical axis of the electronic device 40 so that an appropriate depression angle may be achieved to reduce any error that may be caused by parallax, it would appreciated that in another embodiment of the invention, the housing 26 may be oriented substantially perpendicular with respect to the electronic device 40 and that the sighting grid 30 may be oriented with respect to an open-end of housing 26 to achieve a desired depression angle (zero to three degrees) with regard to the optical axis of the electronic device. For example, when the sighting grid is substantially perpendicular to the housing 26 and the housing is substantially perpendicular to the electronic device, then the depression angle with respect to the optical axis of the electronic device 40 is zero (0) degrees in that the optical axis of the housing 26 (as represented by the sighting grid) is substantially parallel to the optical axis of the electronic device 40. Similarly, when the sighting grid 30 is oriented at an angle of substantially 87 degrees with respect to a lower surface of the housing (or three (3) with respect of an upper surface of the housing) and the housing 26 is substantially perpendicular to the electronic device 26, then a depression angle of three degrees with respect to the optical axis of the electronic device 40 may be achieved as the optical axis of the housing 26, as presented by the sighting grid 30, is oriented at an angle of three (3) degrees with respect to the optical axis of the electronic device.

Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

What is claimed is:

1. A viewfinder assembly comprising:
a casing securely attached to an electronic device, said case at least partially enclosing a back surface of said electronic device;
a stem attached to said casing,
a viewfinder housing engaging said stem, said stem offsetting said viewfinder housing from a plane parallel to the back-surface of said electronic device.

2. The viewfinder assembly of claim 1, wherein said casing fully encloses said back surface of said electronic device.

3. The viewfinder assembly of claim 1, wherein said viewfinder housing comprises:
an open-ended housing; and
a sighting grid comprising a plurality of horizontal lines intersecting a plurality of vertical lines contained within said open-ended housing, said sighting grid being oriented between substantially zero and three degrees with respect to said open-ended housing.

4. The viewfinder assembly of claim 3, wherein the sighting grid is disposed within said open-ended housing furthest from said electronic device.

5. The viewfinder assembly of claim 1, wherein said viewfinder housing is oriented with respect to an optical axis of said electronic device.

6. The viewfinder assembly of claim 5 wherein said orientation of the viewfinder housing creates a depression angle substantially between zero (0) and three (3) degrees between said sighting grid and the optical axis of said electronic device.

7. The viewfinder assembly of claim 1, wherein said viewfinder housing is removably engaged with said stem.

8. The viewfinder assembly of claim 7, wherein said viewfinder housing is slidably engagable with said stem.

9. The viewfinder assembly of claim 7, wherein each of said stem and said viewfinder housing comprises:
an engagement means.

10. The viewfinder assembly of claim 9, wherein said engagement means is selected from a group consisting of: a T-slot, a keyway slot, a tapered slot, a snap fit, a magnetic coupling, and screw mount.

11. The viewfinder assembly of claim 1, wherein said stem is attached to at least one of:
a top and a side of said case.

12. The viewfinder assembly of claim 1, wherein said electronic device is a cellular telephone.

13. A case for retaining a cellular telephone comprising:
a cover at least partially covering a back of an electronic device;
an engagement means attached to said cover; and
a viewfinder housing containing a second engagement means, wherein the second engagement means engages said engagement means.

14. The case of claim 13, wherein said engagement means comprises a T-slot-female and said second engagement means comprises a T-slot-male.

15. The case of claim 13, wherein said engagement means comprises a T-slot-male and said second engagement means comprises a T-slot-female.

16. The case of claim 13, wherein said engagement means is attached to at least one of:
a top of said case and a side of said case.

17. The case of claim 13, wherein said cover fully covers said back of said electronic device.

18. The case of claim 13, wherein said engagement means is oriented such that said viewfinder housing is oriented with respect to an optical axis of a lens within said electronic device.

19. The case of claim 18, wherein said orientation of said housing creates a depression angle substantially between zero (0) and three (3) degrees.

20. The case of claim 13, wherein said viewfinder housing comprises:
an open-ended housing; and
a sighting grid, said sighting grid being oriented between substantially zero (0) and three (3) degrees with respect to said open-ended housing.
